(19) United States
(12) Patent Application Publication
(10) Pub. No.: US 2022/0095641 A1
(43) Pub. Date: Mar. 31, 2022

(54) METHODS OF PROCESSING CHOCOLATE COVERED FROZEN FOOD PRODUCTS

(71) Applicant: Tru Fru, LLC, Salt Lake City, UM (US)

(72) Inventor: Taz Murray, Salt Lake City, UT (US)

(21) Appl. No.: 17/356,847

(22) Filed: Jun. 24, 2021

Related U.S. Application Data
(60) Provisional application No. 63/085,832, filed on Sep. 30, 2020.

(51) Int. Cl. A23G 1/54; A23G 1/30; A23G 1/36; A23L 19/00; A23P 20/10; A23P 20/18; A23B 7/04; A23P 20/20; B65G 15/32

(52) U.S. Cl. CPC A23G 1/54; A23G 1/305; A23G 1/36; A23L 19/05; A23P 20/11; B65G 2201/0202; A23B 7/0416; A23P 20/20; B65G 15/32; A23V 2002/00; A23P 20/18

(57) ABSTRACT

A method of applying thin layers of a molten chocolate onto a frozen food product, in some instances fruit, that is at temperatures below 0° C. in such a way that prevents discoloration and brittleness of the applied chocolate.

### BACKGROUND OF THE INVENTION

### 1. Field of the Invention

The present disclosure generally relates to methods of processing chocolate covered frozen food products.

### 2. Background and Related Art

Many people enjoy chocolate covered confections.

### BRIEF SUMMARY OF THE INVENTION

The present invention relates to improved methods for enrobing a frozen food product in an untempered, pure cocoa butter chocolate in such a way that prevents the chocolate from becoming cloudy or frangible. The invention also relates to the ability to envelop the frozen food product in at least a thin layer of chocolate, and then rapidly chill and freeze the chocolate covered frozen food product. It is incredibly unique in the confection industry to coat any frozen product. It is equally as inventive to do so using a pure cocoa butter chocolate applied in multiple thin layers.

In some embodiments, the frozen food product includes a frozen fruit. In some embodiments, the frozen fruit includes a raspberry, a blueberry, a slice of banana, a strawberry, or a cherry.

In some embodiments, an enrobing chocolate comprises a pure cocoa butter chocolate with additional cocoa butter, resulting in a pure, high cocoa content chocolate. Increasing the amount of cocoa butter in chocolate decreases the melting point of the chocolate to achieve a low viscosity chocolate with a good flow characteristic. In some embodiments, the chocolate is untempered and processed at a temperature between about 37.8° C. and about 43.3° C. Using untempered chocolate allows rapid cooling and freezing of the enrobed frozen food product as soon as the chocolate is applied, thereby preventing discoloration and brittleness of the chocolate coating.

In some embodiments, the frozen food product is received for processing, including whole pieces and partial pieces. Accordingly, in some embodiments, a first step in the process includes sorting the frozen food product. Sorting removes any pieces of the frozen food product that are too small to process and distributes the frozen food product along a conveyer belt creating, space between the individual pieces. In some embodiments, a next step includes enrobing the frozen food product to completely coat it in a first thin layer of the chocolate. In some embodiments, the first thin layer of chocolate includes white chocolate. In some embodiments, the enrobed frozen food product then undergoes a second sorting step to provide additional space between the individual pieces of the enrobed frozen food product. In some embodiments, a next step includes conveying the enrobed frozen food product along a shaking belt and through high-velocity blowers to remove all chocolate in excess of a thin layer. In some embodiments, the enrobed frozen food product is then conveyed along a cooling belt to harden a bottom surface of the chocolate that is in contact with the cooling belt. In some embodiments, the enrobed frozen food product is then conveyed through a second enrober where it is coated in a second thin layer of chocolate. In some embodiments, the second layer of chocolate includes a dark chocolate or a milk chocolate. Because the chocolate is untempered, the enrobed frozen food product is immediately cooled and frozen. In some embodiments, it is then packaged in a refrigerated environment to prevent condensation from forming on the enrobed frozen food product.

Reference throughout this specification to features, advantages, or similar language does not imply that all the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment, but may refer to every embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The features and advantages of the present disclosure will become more fully apparent from the following description and appended claims or may be learned by the practice of the invention as set forth hereinafter.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail using the accompanying drawings in which:

FIG. 1 shows an elevation view of a frozen raspberry or other frozen food product;

FIG. 2 shows an elevation view of a drupelet, individual pieces of a raspberry;

FIG. 3 shows a flow diagram comprising the steps of chocolate processing;

FIG. 4 shows a flow diagram of a sorting step;

FIG. 5 shows a flow diagram of a first enrobing step;

FIG. 6 shows an elevation view of a shake and blow step;

FIG. 7 shows a flow diagram of a second enrobing step; and

FIG. 8 shows a cross-sectional view of an enrobed frozen raspberry or other frozen food product.

### DETAILED DESCRIPTION OF THE INVENTION

The term “food product” refers to all substances that are usually composed of carbohydrates, fats, proteins, or water, and can be eaten or drunk by any animal, including humans, for nutrition or pleasure, energy, or building tissue.

The term “drupelet” refers to an individual piece of fruit with skin and a central seed that forms a fleshy, aggregate fruit.

The terms “brittleness” and “frangible” refer to a chocolate coating that is easily broken, cracked, or snapped.

The terms “discoloration” and “clouding” refer to a chocolate coating that exhibits a hazy surface appearance.

The present invention relates to improved methods for enrobing a frozen food product in untempered, pure cocoa butter chocolate in such a way that prevents the chocolate from becoming cloudy and frangible. The invention also relates to the ability to envelop the frozen food product in at least a thin layer of chocolate and then rapidly chill and freeze the chocolate covered frozen food product.

Many people enjoy chocolate covered confections. Conventional methods for coating chocolate covered confections include enrobing a confection with a tempered, high viscosity robing chocolate. Conventional robing chocolate commonly includes supplemental agents, such as coconut oil or butter, to decrease the melting point of the chocolate, thereby creating a “compound coating.” Chocolate with a low melting point enables a sensation referred to as “meltaway” wherein the chocolate begins to melt immediately when placed in a consumer's mouth. Additionally, compound coatings create a softer chocolate that is more pleasing to bite into when frozen. When enrobing a frozen food product with typical compound coatings, the high viscosity robing chocolate tends to adhere to the frozen food product creating an undesirable, thick layer of chocolate rapidly. Lastly, one skilled in the art will appreciate that by conventional methods, processing chocolate typically requires tempering the chocolate to achieve an evenly colored coating.

Using the present invention, it is possible to enrobe a frozen food product with an untempered, low viscosity, pure cocoa butter chocolate to achieve thin, evenly colored layers. It is incredibly unique in the confection industry to coat any frozen product. It is equally as inventive to do so using a pure cocoa butter chocolate applied in multiple thin layers. The special blend of pure cocoa butter chocolate decreases the melting point of the chocolate to achieve the meltaway sensation without including any supplemental agents. The thin layers allow a consumer to bite into the frozen product effortlessly. Finally, processing untempered chocolate allows the enrobed frozen food product to be rapidly cooled and flash frozen immediately after enrobing, thereby eliminating the need to cool a tempered chocolate slowly.

A description of embodiments of the present invention will now be given with reference to the Figures. It is expected that the present invention may take many other forms and shapes. Hence the following disclosure is intended to be illustrative and not limiting, and the scope of the invention should be determined by reference to the appended claims.

Referring now to FIGS. 1-8.

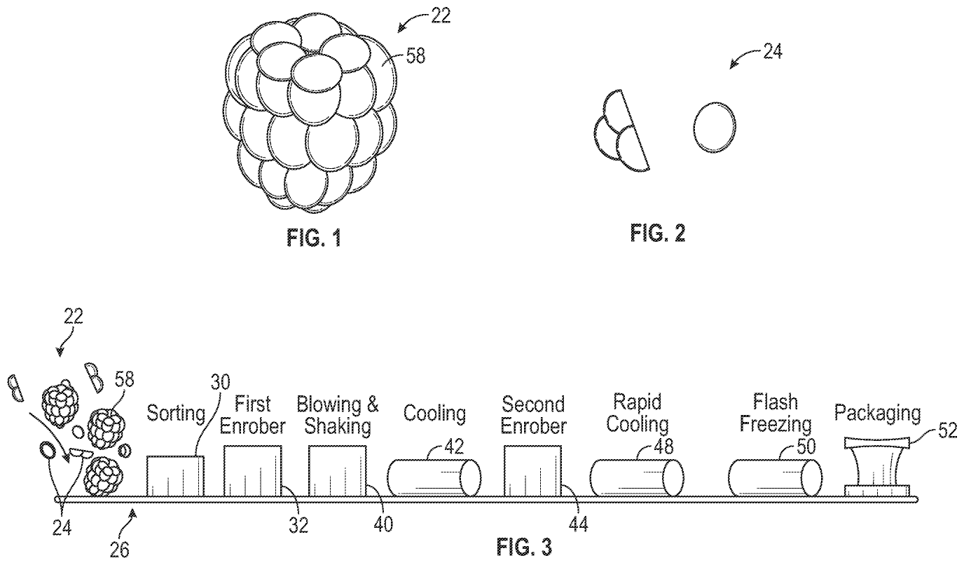

FIG. 1 shows an elevation view of a frozen raspberry 58 or other frozen food product 22. FIG. 2 shows an elevation view of a drupelet 24. A drupelet 24 is an individual piece of fleshy, aggregate fruit with skin and a central seed. An individual raspberry is formed from multiple drupelets 24. FIG. 3 shows a flow diagram comprising an overview of the steps of the present invention. Each step includes processing the frozen food product 22 along a conveying system 26 to create an enrobed frozen food product 28.

Those skilled in the art will appreciate that embodiments of the present invention embrace a variety of different configurations. For example, in one embodiment, the frozen food product 22 comprises a fruit. In another embodiment, the frozen food product 22 comprises a raspberry, a blueberry, a slice of banana, a strawberry, or a cherry.

In some embodiments, the frozen food product 22 is transported along a conveying system 26, comprised of multiple conveyor belts. Each conveyor belts travels with increasing speed relative to the previous step to create separation between the frozen food products 22, and later in the process, the enrobed frozen food products 28. One skilled in the art will appreciate that by conventional methods, each conveyor belt typically travels at a decreasing speed relative to the previous step positioning the confections closer together.

In some embodiments, the frozen food product 22 is received for processing, including whole pieces and partial pieces. Accordingly, in some embodiments, a first step in the process includes sorting 30 the frozen food product 22 in such a way that discards pieces of the frozen food product 22 that are too small to process. Additionally, the sorting step creates space between individual pieces of the frozen food product 22 to prevent clusters from forming at later steps in the process.

In some embodiments, the frozen food product 22 passes through a first enrober 32 to achieve a first thin layer of chocolate 34 and emerges as an enrobed frozen food product 28. In some embodiments, the enrobed frozen food product 28 then undergoes a second sorting step to provide additional space between the individual pieces of the enrobed frozen food product. In some embodiments, the enrobed frozen food product 28 is then conveyed along a shaking belt 36 through blowers 38 to remove all chocolate in excess of a thin layer; this step is referred to as “blowing and shaking” 40. In some embodiments, the enrobed frozen food product 28 is then conveyed along a cooling belt 42, at a temperature between about 1.7° C. and about 7.2° C., and through a second enrober 44 to achieve a second, thin layer of chocolate 46. In some embodiments, the enrobed frozen food product 28 is then conveyed through a rapid cooling tunnel 48 at a temperature below 1.7° C., followed by flash freezing 50 in an Individual Quick Frozen (“IQF”) unit at a temperature below −18° C. The IQF includes a perforated belt having high velocity, frozen air blowing up through the belt, and causing the enrobed frozen food product 28 to lift off the belt and separate from other enrobed frozen food products 28. The IQF is a standard machine in the industry; however, it is not typically used to process enrobed chocolate products. In some embodiments, the next step includes packaging 52 the enrobed frozen food product 28. Packaging 52 takes place in a refrigerated environment, at a temperature below 4° C., as quickly as possible to prevent condensation from forming on the enrobed frozen food product 28.

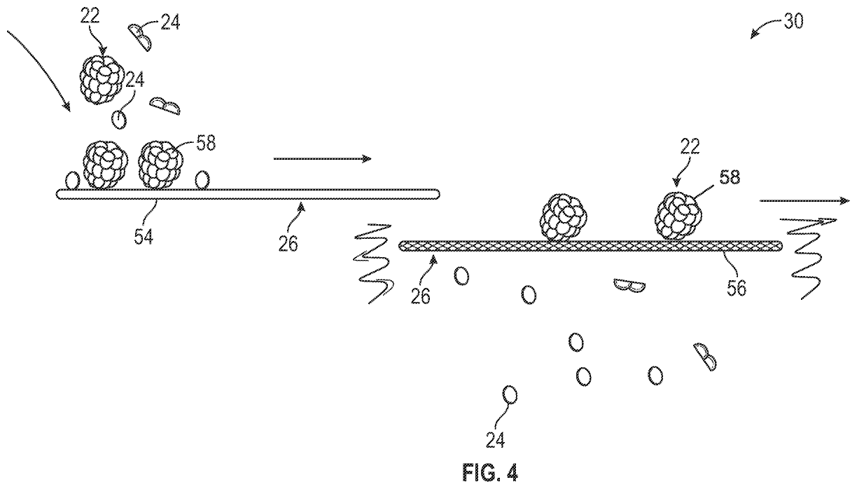

FIG. 4 is a schematic diagram of the sorting step 30 wherein whole pieces, and partial pieces of the frozen food product 22 are received, and those pieces of the frozen food product 22 that are too small to be processed are discarded. The sorting step 30 also provides space between the individual pieces of the frozen food product 22 to prevent clumps or clusters of the frozen food product 22 from forming at later steps in the process. The frozen food product 22 initially travels along an infeed belt 54 and onto a sorting belt 56. The infeed belt 54 and the sorting belt 56 form part of the conveying system 26. In some embodiments, the infeed belt 54 and the sorting belt 56 travel at a speed between about 0 meters per minute (“m/m”) and about 15 m/m, and more commonly at a speed between about 4 m/m and about 10 m/m. In some embodiments, the sorting belt 56 includes wire mesh with openings that are large enough to allow small pieces of the frozen food product 22 to pass through the openings. Furthermore, in some embodiments, the sorting belt 56 vibrates to encourage the small pieces of the frozen food product 22 to pass through the openings, and the small pieces of the frozen food product 22 that fall through the sorting belt 56 are removed from the process. In some embodiments, wherein the frozen food product 22 is a frozen raspberry 58, the openings in the sorting belt 56 are large enough to allow small pieces of the frozen raspberry 58, or drupelets 24, to fall through. The sorting step 30 prevents the drupelets 24 from falling through an enrobing belt at a subsequent step in the process and thereby adding undesirable moisture to the chocolate below. Furthermore, the sorting step is performed in such a way that minimizes friction and motion on the thin skin of the frozen raspberry 58 so that the frozen raspberry 58 does not become damaged.

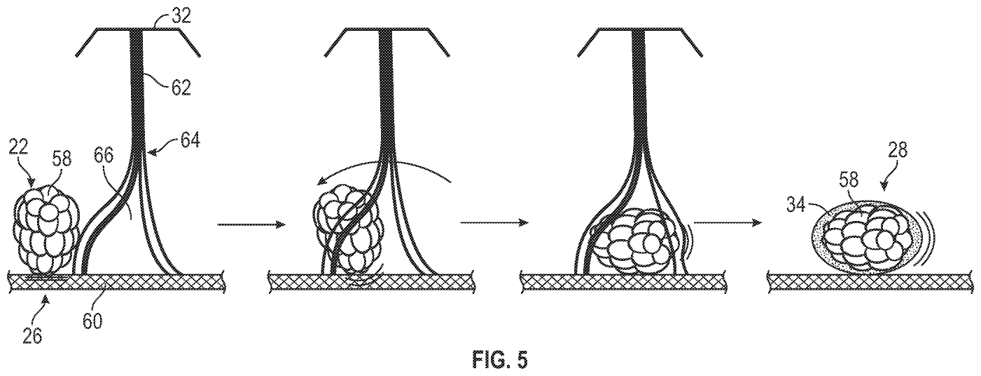

FIG. 5 is a schematic diagram of the first enrobing step. In some embodiments, the chocolate used to enrobe the frozen food product 22 comprises a pure cocoa butter chocolate with additional cocoa butter, resulting in a pure, high cocoa content chocolate 62. Increasing the amount of cocoa butter in chocolate decreases the melting point of the chocolate to achieve a low viscosity chocolate with a good flow characteristic. Because of the low melting point of the pure, high cocoa content chocolate 62, the chocolate begins to melt immediately when consumed, creating a sensation referred to in the industry as “meltaway.” Using the pure, high cocoa content chocolate 62 obviates the need for incorporating other agents into the chocolate, such as coconut oil and butter. Those skilled in the art will appreciate the incredible uniqueness of using a real chocolate, made from pure cocoa butter, to coat a frozen confection. In some embodiments, the pure, high cocoa content chocolate 62 is untempered and processed at a temperature between about 37.8° C. and about 43.3° C. Using untempered chocolate allows rapid cooling and freezing of the enrobed frozen food product 28 as soon as the chocolate is applied.

The enrobing step includes conveying the frozen food product 22 along an enrobing belt 60 under a curtain 64 of the pure, high cocoa content chocolate 62 in such a way that completely coats, or envelopes, the frozen food product 22 in the pure, high cocoa content chocolate 62. The enrobing belt 60 forms part of the conveying system 26 and includes wire mesh to allow recovery of excess chocolate that drains through the enrobing belt 60 as the frozen food product 22 is enveloped. Those skilled in the art will appreciate that in some embodiments, the enrobing belt 60 travels at a speed between about 0 m/m and about 15 m/m, and more commonly at a speed between about 5 m/m and about 10 m/m, whereas typical enrobing belts in the industry travel at a speed of approximately 2 m/m. The first enrober 32 includes custom-made pumps equipped to process the low viscosity chocolate and forces the pure, high cocoa content chocolate 62 to continuously flow downward over the enrobing belt 60 creating the free-falling curtain 64 of the chocolate.

In some embodiments, a plate resides directly below the enrobing belt 60 referred to as a “bottomer.” As the curtain 64 of pure, high cocoa content chocolate 62 cascades downward, it contacts the enrobing belt 60 and the bottomer creating a wave 66. As the frozen food product 22 travels under the curtain 64 of pure, high cocoa content chocolate 62, the wave 66 engulfs the frozen food product 22 and causes it to tip over, thereby completely coating the frozen food product 22. Because of the low viscosity and good flow characteristic of the pure, high cocoa content chocolate 62, the chocolate captures the entire surface of the frozen food product 22 filling any irregularities. The pure, high cocoa content chocolate 62 begins to harden immediately upon contacting the frozen food product 22. As the frozen food product 22 exits the first enrober 32, it emerges as an enrobed frozen food product 28 coated in the first thin layer of chocolate 34. In some embodiments, the first thin layer of chocolate 34 includes white chocolate. In some embodiments, the enrobed frozen food product 28 then undergoes a second sorting step to provide additional space between the individual pieces of the enrobed frozen food product.

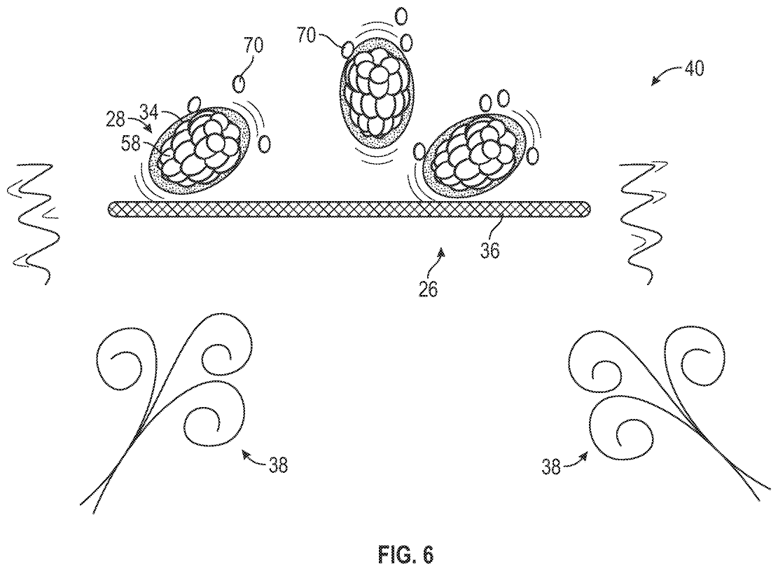

FIG. 6 shows an elevation view of the blowing and shaking step 40. In some embodiments, the enrobed frozen food product 28 is conveyed along an aggressively shaking belt 36 and through blowers 38 creating high-velocity air blowing up through the belt to remove all chocolate in excess of a thin layer. The shaking belt 36 includes wire mesh with openings to allow excess chocolate 70 to fall through the openings. The shaking belt 36 forms part of the conveying system 26. In some embodiments, the aggressive motion of the shaking belt 36, combined with the forced air blowing up through the belt from the blowers 38, propels the enrobed frozen food product 28 into irregular motion causing any excess chocolate 70 to shed off of the enrobed frozen food product 28, and leaving only a first thin layer of chocolate 34. In some embodiments, the thickness of the first thin layer of chocolate 34 is between about 0 millimeters (“mm”) and about 5 mm, and more commonly between about 1 mm and about 2 mm. In some embodiments, the excess chocolate 70 that falls through the openings in the shaking belt 36 is removed from the process. In other embodiments, the excess chocolate 70 that falls through the openings in the shaking belt 36 is recycled into the process.

In some embodiments, the enrobed frozen food product 28 is then conveyed along a cooling belt 42, at a temperature between about 0° C. and about 10° C., more commonly between about 1.7 C and about 7.2° C., thereby hardening the chocolate on the bottom of the enrobed frozen food product 28. The cooling belt 42 forms part of the conveying system 26. In some embodiments, the cooling belt 42 travels at a speed between about 0 m/m and about 15 m/m, and more commonly at a speed between about 6 m/m and about 10 m/m.

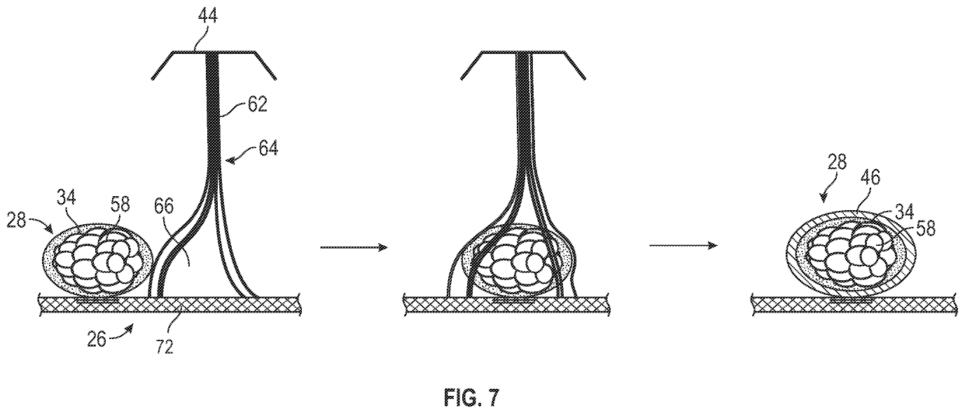

FIG. 7 shows a flow diagram of the second enrobing step. In some embodiments, the enrobing chocolate comprises the low viscosity, untempered, pure high cocoa content chocolate 62, processed at a temperature between about 37.8° C. and about 43.3° C. The second enrobing step includes conveying the enrobed frozen food product 28 along a second enrobing belt 72 under a curtain 64 of the pure, high cocoa content chocolate 62 in such a way that coats the enrobed frozen food product 28 in a second thin layer of chocolate 46. Those skilled in the art will appreciate how incredibly unique it is to apply a second thin layer of chocolate to a frozen confection.

The second enrobing belt 72 forms part of the conveying system 26 and includes wire mesh to allow recovery of excess chocolate that drains through the second enrobing belt 72 as the enrobed frozen food product 28 is enveloped. Those skilled in the art will appreciate that in some embodiments, the second enrobing belt 72 travels at a speed between about 0 m/m and about 15 m/m, and more commonly at a speed between about 6 m/m and about 10 m/m. The second enrober 44 includes custom-made pumps designed to process low viscosity chocolate and forces the pure, high cocoa content chocolate 62 to continuously flow downward over the second enrobing belt 72 creating the free-falling curtain 64. In some embodiments, a plate resides directly below the enrobing belt 60 referred to as a “bottomer.” A wave 66 is created as the curtain 64 of pure, high cocoa content chocolate 62 cascades downward and contacts the second enrobing belt 72 and the bottomer. The wave 66 engulfs the enrobed frozen food product 28 as it travels under the curtain 64 of pure, high cocoa content chocolate 62. In some embodiments, the enrobed frozen food product 28 does not flip over during the second enrobing step, thereby creating feet along a bottom surface of the second thin layer of chocolate 46 where the enrobed frozen food product contacts the second enrobing belt 72.

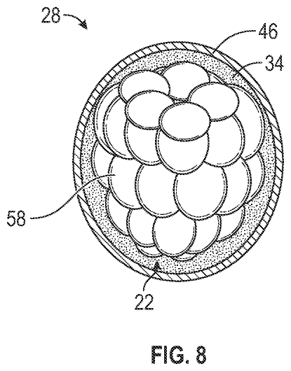

FIG. 8 shows a cross-sectional view of the enrobed frozen food product 28 as it exits the second enrober 44, coated in the first thin layer of chocolate 34, and the second thin layer of chocolate 46. In some embodiments, the thickness of the second thin layer of chocolate 46 is between about 0 mm and about 5 mm, and more commonly between about 1 mm and about 2 mm. In some embodiments, the second thin layer of chocolate 46 includes dark chocolate. In some embodiments, the second thin layer of chocolate 46 includes milk chocolate.

In some embodiments, the enrobed frozen food product 28 is conveyed through a rapid cooling tunnel 48 immediately after the second enrober 44 and cooled to a temperature below 1.7° C. In some embodiments, rapid cooling tunnel 48 includes a second cooling belt 74 that forms part of the conveying system 26. In some embodiments, the second cooling belt 74 travels at a speed between about 0 m/m and about 15 m/m, and more commonly at a speed between about 6 m/m and about 10 m/m.

The enrobed frozen food product 28 then undergoes flash freezing 50 in an IQF unit to a temperature below −18° C. The IQF includes a perforated belt having high velocity, frozen air blowing up through the belt, and causing the enrobed frozen food product 28 to lift off the belt and separate from other enrobed frozen food products 28. The IQF is a standard machine in the industry; however, it is not typically used to process enrobed chocolate products. After flash freezing 50, the enrobed frozen food product 28 undergoes packaging 52. Packaging 52 takes place in a refrigerated environment, at a temperature below 4° C., as quickly as possible to prevent condensation from forming on the enrobed frozen food product 28.

The present invention creates a unique and improved process for enrobing a frozen food product in thin layers of untempered, pure, high cocoa content chocolate in such a way that prevents the chocolate from becoming cloudy and frangible. One skilled in the art will appreciate the uniqueness of coating any frozen confection in chocolate. Moreover, one skilled in the art will equally appreciate the ingenuity of using pure cocoa butter chocolate with additional cocoa butter to achieve a low viscosity, low melting point chocolate without including other agents such as coconut oil or butter. Processing pure, real chocolate obviates the need for tempering the chocolate before the enrobing step. Because the chocolate is untempered, it can be cooled and frozen immediately after application onto the frozen food product. In this way, the color and texture of the chocolate is preserved, thereby preventing discoloration or brittleness of the chocolate coating. In some embodiments, the frozen food product is first enrobed in a thin layer of white chocolate followed by a thin layer of dark or milk chocolate. As the frozen food product is enrobed in chocolate, it travels along a conveying system at least four times as fast as conventional methods. For example, the first enrobing belt in the present invention travels at a speed between about 5 m/m and about 10 m/m. In contrast, enrobing belts in the industry typically travel at a speed of 2 m/m. One skilled in the relevant art will recognize that applying chocolate onto a frozen confection by conventional methods (using a high viscosity, compound coating, and slower conveyor belts) results in thick, frozen layers that are difficult for a consumer to bite into. However, the present invention's enrobing methods create a frozen food product enrobed in multiple, thin layers of chocolate that is pleasing to bite into.

The present invention may be embodied in other specific forms without departing from its spirit or essential characteristics. The described embodiments are to be considered in all respects, only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by Letters Patent is:

1. A process of applying an untempered chocolate onto a frozen food product that forms thin layers of the chocolate and prevents the chocolate from becoming cloudy and frangible, comprising:
obtaining a frozen food product;
obtaining a low viscosity, untempered, chocolate containing pure cocoa butter;
applying a first layer of the chocolate by conveying the frozen food product along a belt under an enrobing curtain of the chocolate to envelop the frozen food product in chocolate;
conveying an enrobed frozen food product along a vibrating perforated belt having pressurized air passing up through the belt to remove all chocolate in excess of a thin layer;
flash cooling the frozen food product to a temperature below 1.7° C.; and
freezing the frozen food product to a temperature below −18° C.

2. The process as recited in claim 1, wherein the food product is a fruit.

3. The process as recited in claim 1, wherein the food product is a raspberry.

4. The process of claim 1, wherein the step of enrobing comprises enveloping the frozen food product in a first layer of white chocolate and then enrobing the frozen food product in a second layer comprising low viscosity untampered pure cocoa butter chocolate.

5. The process of claim 4, wherein the second layer contains dark chocolate.

6. The process of claim 4, wherein the second layer contains milk chocolate.

7. The process of claim 1, further comprising:
rapidly packaging the enrobed frozen food product at a temperature below 4° C., thereby creating a packaged product and freezing the packaged product in such a way that prevents condensation from forming on the enrobed frozen food product.

8. A process of applying an untempered chocolate onto a frozen food product that forms thin layers of the chocolate and prevents the chocolate from becoming cloudy and frangible, comprising:
obtaining a frozen food product;
obtaining a low viscosity, untempered, chocolate containing pure cocoa butter;
applying a first layer of white chocolate by conveying the frozen food product along a first enrobing belt under an enrobing curtain of the chocolate to envelop the frozen food product in chocolate;
conveying the frozen food product along a vibrating perforated belt having pressurized air passing up through the belt to remove all chocolate in excess of a thin layer;
cooling the frozen food product to a temperature between about 1.7° C. and about 7.2° C.;
applying a second layer of chocolate, comprising low viscosity untampered pure cocoa butter chocolate, by conveying an enrobed frozen food product along a second enrobing belt under a second enrobing curtain of the chocolate to envelop the enrobed frozen food product in chocolate;
flash cooling the frozen food product to a temperature below 1.7° C.;
freezing the frozen food product to a temperature below −18° C.; and
rapidly packaging the enrobed frozen food product at a temperature below 4° C., thereby creating a packaged product and freezing the packaged product in such a way that prevents condensation from forming on the enrobed frozen food product.

9. The process as recited in claim 8, wherein the food product is a fruit.

10. The process as recited in claim 8, wherein the food product is a raspberry.

11. The process of claim 8, wherein the second layer contains dark chocolate.

12. The process of claim 8, wherein the second layer contains milk chocolate.

13. A process of applying an untempered chocolate onto a frozen food product that forms thin layers of the chocolate and prevents the chocolate from becoming cloudy and frangible, comprising:
obtaining a frozen food product;
obtaining a low viscosity, untempered, chocolate containing pure cocoa butter;
applying a first layer of white chocolate, at a temperature between 37.8° C. and 43.3° C., by conveying the frozen food product along a first enrobing belt, traveling at a speed between about 5 m/m and about 10 m/m, under an enrobing curtain of the chocolate to envelop the frozen food product in chocolate;
conveying an frozen food product along a conveyor belt, having pressurized air passing up through the conveyor belt to remove all chocolate in excess of a thin layer;
cooling the frozen food product to a temperature between about 1.7° C. and about 7.2° C., by conveying the frozen food product along a cooling belt, traveling at a speed between about 6 m/m and about 10 m/m, to harden the chocolate along a bottom surface of the enrobed frozen food product;
applying a second layer of chocolate, comprising low viscosity untampered pure cocoa butter chocolate, at a temperature between 37.8° C. and 43.3° C., by conveying the enrobed frozen food product along a second enrobing belt, traveling at a speed between about 6 m/m and about 10 m/m, under an enrobing curtain of the chocolate to envelop the enrobed frozen food product in chocolate;
flash cooling the frozen food product to a temperature below 1.7° C., by conveying the frozen food product along a second cooling belt, traveling at a speed between about 6 m/m and about 10 m/m;
freezing the frozen food product to a temperature below −18° C.; and
rapidly packaging the frozen food product at a temperature below 4° C., thereby creating a packaged product and freezing the packaged product in such a way that prevents condensation from forming on the enrobed frozen food product.

14. The process as recited in claim 13, wherein the food product is a fruit.

15. The process as recited in claim 14, wherein the food product is a raspberry.

16. The process of claim 13, wherein the second layer contains dark chocolate.

17. The process of claim 13, wherein the second layer contains milk chocolate.

18. The process of claim 13, further comprising:
conveying a frozen raspberry along a vibrating perforated infeed belt, traveling at a speed between about 4 m/m and about 10 m/m, to remove a drupelet from processing by allowing the drupelet to pass through the perforations in the belt and to create space between the individual pieces of frozen raspberry.

19. The drupelet as recited in claim 18, wherein the drupelet is an individual piece of fleshy, aggregate fruit with skin and central seed.
